(19) United States
(12) Patent Application Publication
(10) Pub. No.: US 2015/0007657 A1
(43) Pub. Date: Jan. 8, 2015

(54) INERTIAL SENSOR AND METHOD OF MANUFACTURING THE SAME

(71) Applicant: SAMSUNG ELECTRO-MECHANICS CO., LTD., Suwon-si (KR)

(72) Inventors: Seung Hun HAN, Suwon-si (KR); Jeong Suong YANG, Suwon-si (KR); Sung Jun LEE, Suwon-si (KR); Chang Hyun LIM, Suwon-si (KR)

(73) Assignee: SAMSUNG ELECTRO-MECHANICS CO., LTD., Suwon-si (KR)

(21) Appl. No.: 14/203,078

(22) Filed: Mar. 10, 2014

(30) Foreign Application Priority Data
May 30, 2013 (KR) 10-2013-0061601

(51) Int. Cl. G01P 15/12; G01P 15/08

(52) U.S. Cl. CPC G01P 15/123; G01P 15/0802
USPC 73/514.33; 29/25.35

(57) ABSTRACT

Disclosed herein is an inertial sensor including: a flexible part; a mass body connected to the flexible part; and a support part connected to the flexible part and supporting the mass body in a floated state to displace the mass body, wherein the flexible part has an upper piezoresistor disposed on one surface thereof and a lower piezoresistor disposed on the other surface thereof to detect a displacement of the mass body.

### CROSS REFERENCE TO RELATED ED APPLICATION

This application claims the benefit of Korean Patent Application No. 10-2013-0061601, filed on May 30, 2013, entitled “Inertial Sensor And Method Of Manufacturing The Same” which is hereby incorporated by reference in its entirety into this application.

### BACKGROUND OF THE INVENTION

1. Technical Field

The present invention relates to an inertial sensor and a method of manufacturing the same.

2. Description of the Related Art

Recently, an inertial sensor has been used in various applications, for example, military such as an artificial satellite, a missile, an unmanned aircraft, or the like, vehicles such as an air bag, electronic stability control (ESC), a black box for a vehicle, or the like, hand shaking prevention of a camcorder, motion sensing of a mobile phone or a game machine, navigation, or the like.

The inertial sensor has generally adopted a configuration in which a mass body is adhered to an elastic substrate, such as a membrane, and the like, which is a flexible part, in order to measure acceleration and angular velocity. Through the above-mentioned configuration, the inertial sensor may calculate the acceleration by measuring inertial force applied to the mass body and may calculate the angular velocity by measuring Coriolis force applied to the mass body.

In detail, a method of measuring the acceleration using the inertial sensor will be described below. First, the acceleration may be calculated by Newton's law of motion “F=ma”, where “F” represents inertial force applied to the mass body, “m” represents a mass of the mass body, and “a” is acceleration to be measured. Among others, the acceleration a may be obtained by sensing the inertial force F applied to the mass body and dividing the sensed inertial force F by the mass m of the mass body that is a predetermined value.

Meanwhile, as an example of the inertial sensor, a piezoresistive type of acceleration sensor according to the prior art includes a piezoresistor mounted on a membrane (diaphragm) to sense a displacement of the mass body. However, as the piezoresistor is provided as a single layer, there is a limitation in detecting the displacement of the mass body.

### PRIOR ART DOCUMENT

(Patent Document 1) US 20030209075 A

### SUMMARY OF THE INVENTION

The present invention has been made in an effort to provide an inertial sensor which can have improved sensing sensitivity and efficiency by detecting displacements from an upper piezoresistor and a lower piezoresistor each formed on upper and lower portions of a flexible part and calculating an inertial force by summing detection signals depending on the displacements and can be implemented in a small and light type, and a method of manufacturing the same.

According to a preferred embodiment of the present invention, there is provided an inertial sensor, including: a flexible part; a mass body connected to the flexible part; and a support part connected to the flexible part and supporting the mass body in a floated state to displace the mass body, wherein the flexible part has an upper piezoresistor disposed on one surface thereof and a lower piezoresistor disposed on the other surface thereof to detect a displacement of the mass body.

The flexible part may include an upper piezoresistance wiring electrically connected to the upper piezoresistor and a lower piezoresistance wiring electrically connected to the lower piezoresistor.

The flexible part may include membrane layers formed on the lower piezoresistor and the lower piezoresistance wiring.

The flexible part may include a metal wiring electrically connected to the upper piezoresistance wiring and the lower piezoresistance wiring, the metal wiring being exposed to an outside of the flexible part.

The flexible part may be provided with a metal via hole through which the metal wirings are connected to the upper piezoresistance wiring and the lower piezoresistance wiring.

The flexible part may include a passivation layer covering the upper piezoresistor and the upper piezoresistance wiring.

The upper piezoresistor and the lower piezoresistor may be adjacently disposed to the mass body.

The upper piezoresistor and the lower piezoresistor may be each disposed two by two at both sides based on the mass body to be symmetrical with each other.

The upper and lower piezoresistance wirings may be adjacently disposed to the support part.

The upper piezoresistor and the lower piezoresistor may be each adjacent to the support part and may be disposed two by two to be symmetrical with each other.

According to another preferred embodiment of the present invention, there is provided a method of manufacturing an inertial sensor, including: (A) forming a lower piezoresistance wiring on a base substrate; (B) forming a lower piezoresistor to contact the lower piezoresistance wiring; (C) forming a membrane layer on the lower piezoresistor and the lower piezoresistance wiring; and (D) forming the upper piezoresistor and the piezoresistance wiring on the membrane layer to contact an upper piezoresistor and an upper piezoresistance wiring.

In the (A), a silicon oxide layer may be disposed on the base substrate and the lower piezoresistance wiring may be disposed on the silicon oxide layer.

In the (A), the lower piezoresistance wiring may be formed two by two at both sides based on a central portion of the base substrate.

In the (B), the lower piezoresistor may be disposed two by two at both sides based on a central portion of the base substrate to form a first lower piezoresistor, a second lower piezoresistor, a third lower piezoresistor, and a fourth lower piezoresistor.

In the (D), the upper piezoresistor may be disposed two by two at both sides based on a central portion of the base substrate to form a first upper piezoresistor, a second upper piezoresistor, a third upper piezoresistor, and a fourth upper piezoresistor.

The method of manufacturing an inertial sensor may further include: after the (D), (E) forming a passivation layer on the upper piezoresistor and the upper piezoresistance wiring.

The method of manufacturing an inertial sensor may further include: after the (E), (F) forming a via hole through which a metal wiring insertion path is formed in the membrane layer and the passivation layer to connect the metal wiring to the lower piezoresistance wiring and the upper piezoresistance wiring, respectively.

The method of manufacturing an inertial sensor may further include: after the (F), (G) filling a metal in the via hole.

The method of manufacturing an inertial sensor may further include: after the (G), (H) deposing a metal wiring to contact the metal filled in the via hole and forming a pattern.

The method of manufacturing an inertial sensor may further include: after the (H), (I) forming a mass body and a support part by selectively etching the base substrate.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a cross-sectional view schematically illustrating an inertial sensor according to a preferred embodiment of the present invention;

FIG. 2 is a diagram illustrating a wheatstone bridge structure according to a first preferred embodiment for one-axis direction signal detection, in the inertial sensor illustrated in FIG. 1;

FIG. 3 is a diagram illustrating a wheatstone bridge structure according to a first preferred embodiment for the other-axis direction signal detection, in the inertial sensor illustrated in FIG. 1;

FIG. 4 is a diagram illustrating a wheatstone bridge structure according to a second preferred embodiment for one-axis direction signal detection, in the inertial sensor illustrated in FIG. 1;

FIG. 5 is a diagram illustrating a wheatstone bridge structure according to a second preferred embodiment for the other-axis direction signal detection, in the inertial sensor illustrated in FIG. 1;

FIG. 6 is flow chart schematically illustrating a method of manufacturing an inertial sensor illustrated in FIG. 1; and

FIGS. 7A to 7I are process diagrams schematically illustrating the method of manufacturing an inertial sensor illustrated in FIG. 6, FIG. 7A is a diagram illustrating a process of forming a lower piezoresistance wiring, FIG. 7B is a diagram illustrating a process of forming a lower piezoresistor, FIG. 7C is a diagram illustrating a process of forming a membrane layer, FIG. 7D is a diagram illustrating a process of forming an upper piezoresistor and an upper piezoresistance wiring, FIG. 7E is a diagram illustrating a process of forming a passivation layer, FIG. 7F is a diagram illustrating a process of forming a via hole, FIG. 7G is a diagram illustrating a process of filling a metal, FIG. 7H is a diagram illustrating a process of depositing a metal and forming a pattern, and FIG. 7I is a diagram illustrating a process of forming a mass body and a support part.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first,” “second,” “one side,” “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

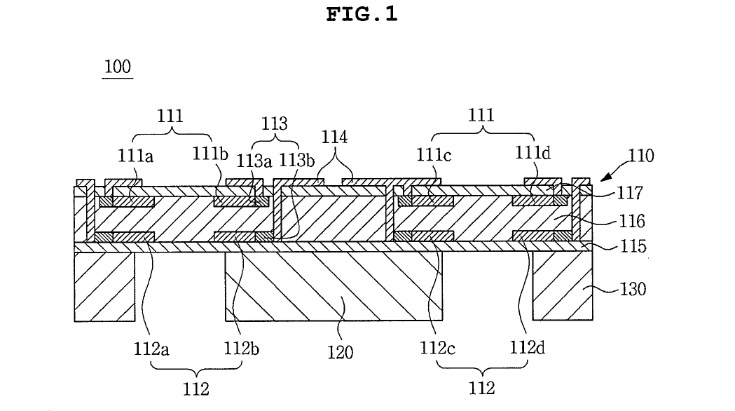

FIG. 1 is a cross-sectional view schematically illustrating an inertial sensor according to a preferred embodiment of the present invention. As shown, an inertial sensor 100 includes a flexible part 110, a mass body 120, and a support part 130.

Further, the flexible part 110 is formed in a plate shape and is configured of a flexible substrate, such as a membrane, a beam, and the like, which have elasticity to allow the mass body 120 to be displaced.

Further, the mass body 120 is coupled with one surface of the flexible part 110 and is displaced by inertial force, external force, Coriolis force, driving force, and the like.

Further, the support part 130 is coupled with one surface of the flexible part and supports the mass body 120 in a floated state to be able to displace the mass body 120.

In this case, the mass body 120 is disposed at a central portion of the flexible part 110, the support part 130 is formed in a hollow shape, such that the mass body is disposed in the hollow part to be displaced, and as the support part 130 is disposed at an edge portion of the flexible part 110, a space to allow the mass body 120 to be displaced is secured.

Further, the mass body 120 may be formed in a cylindrical shape and the support part 130 may be formed in a cylindrical shape or a square pillar shape. Further, the shape of the mass body 120 and the support part 130 is not limited thereto, and therefore may be formed in any shape known in the art.

Meanwhile, the flexible part 110, the mass body 120, and the support part 130 which are described above may be formed by selectively etching a silicon on insulator (SOI) substrate on which a micro electro mechanical systems (MEMS) process is easily performed.

Therefore, a silicon oxide layer (SiO2) 115 of the SOI substrate may remain between the mass body 120 and the flexible part 110 and between the support part 130 and the flexible part 110. However, the flexible part 110, the mass body 120, and the support part 130 are not necessarily formed by etching the SOI substrate, but may also be formed by etching a general silicon substrate, or the like.

Hereinafter, the technical configuration, the shape, the organic coupling, and the acting effect of the flexible part of the inertial sensor according to the preferred embodiment of the present invention will be described in more detail.

The flexible part 110 is configured of an upper piezoresistor 111, a lower piezoresistor 112, a piezoresistance wiring 113, a metal wiring 114, the silicon oxide layer 115, a membrane layer 116, and a passivation layer 117.

Further, as the laminated order, a lower portion of the flexible part 110 coupled with the mass body 120 is provided with the silicon oxide layer 115 and an upper portion of the silicon oxide layer 115 is provided with the lower piezoresistor 112 and a lower piezoresistance wiring 113b. Further, the membrane layer 116 is disposed on the lower piezoresistor 112 and the piezoresistance wiring and the upper piezoresistor 111 and the upper piezoresistance wiring 113a are disposed on the membrane layer 116. Further, the passivation layer 117 is disposed on the upper piezoresistor 111 and the upper piezoresistance wiring 113a and the metal wiring 114 is exposed on the passivation layer 117.

Further, the flexible part 110 is formed in a duplex type in which the upper piezoresistor 111 is disposed on one surface thereof and the lower piezoresistor 112 is disposed on the other surface thereof. Further, the sensing sensitivity and efficiency may be improved by calculating the inertial force by summing detected signals from the upper piezoresistor 111 and the lower piezoresistor 112, respectively.

In more detail, based on the laminated direction, the upper piezoresistor 111 is disposed on the membrane layer 116 and the lower piezoresistor 112 is disposed beneath the membrane layer 116. This considers the fact that when the flexible part 110 is displaced, a stress most frequently occurs on the upper and lower portions of the flexible part.

Further, the upper piezoresistor 111 and the lower piezoresistor 112 have resistance changed in response to an elastic deformation of the flexible part 110. Further, the upper piezoresistor 112 and the lower piezoresistor 112 are adjacently disposed to the mass body 120 coupled with the flexible part 110. This considers the fact that when the mass body is displaced, a stress most frequently occurs at a portion adjacent to the mass body 120.

Further, the upper piezoresistor 112 and the lower piezoresistor 112 are adjacently disposed to the support part 130 coupled with the flexible part 110. This considers the fact that when the mass body 120 is displaced, a stress most frequently occurs at a portion adjacent to the support part 130.

That is, the upper piezoresistor 111 is configured of a first upper piezoresistor 111a, a second upper piezoresistor 111b, a third upper piezoresistor 111c, and a fourth upper piezoresistor 111d and the first upper piezoresistor 111a and the fourth upper piezoresistor 111d are adjacently disposed to the support part and the second upper piezoresistor 111b and the third upper piezoresistor 111c are adjacently disposed to the mass body 120.

Further, the lower piezoresistor 112 is configured of a first lower piezoresistor 112a, a second lower piezoresistor 112b, a third lower piezoresistor 112c, and a fourth lower piezoresistor 112d and the first lower piezoresistor 112a and the fourth lower piezoresistor 112d are adjacently disposed to the support part and the second lower piezoresistor 112b and the third lower piezoresistor 112c are adjacently disposed to the mass body 120.

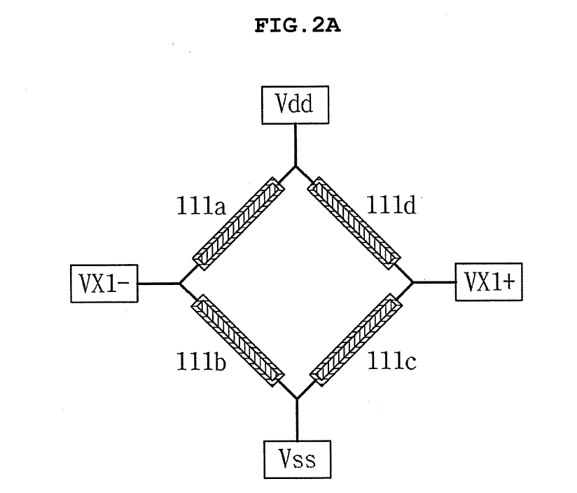

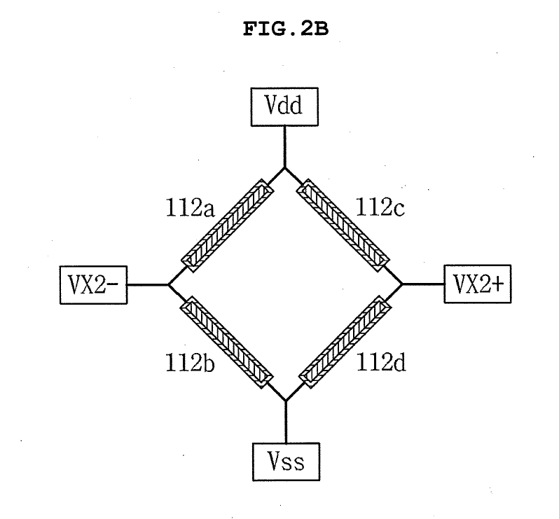

Further, the upper piezoresistor 111 and the lower piezoresistor 112 are applied with a stress in an opposite direction to each other when the flexible part 110 is bent and sum a signal depending on the applied stress to perform sensing. Further, the signal detection and the sensing method depending on the upper piezoresistor 111 and the lower piezoresistor 112 will be described in detail with reference to FIGS. 2 to 5.

Next, the piezoresistance wiring 113 is configured of an upper piezoresistance wiring 113a electrically connected to the upper piezoresistor 111 and a lower piezoresistance wiring 113b electrically connected to the lower piezoresistor 112.

Further, the metal wiring 114 is electrically connected to the upper piezoresistance wiring 113a and the lower piezoresistance wiring 113b, respectively and is exposed to the outside of the flexible part 110 to be connected to the external substrate, and the like, through wire bonding, and the like, to apply the detected signal from the upper piezoresistor 111 and the lower piezoresistor 112.

Further, the membrane layer 116 may be formed with a via hole to connect the metal wiring 114 to the upper piezoresistance wiring 113a and the lower piezoresistance wiring 113b, respectively.

Further, as described above, the silicon oxide layer 115 is disposed between the mass body 120 and the flexible part 110 and between the support part 130 and the flexible part 110 and the lower piezoresistor 112 and the lower piezoresistance wiring 113b may be disposed on the silicon oxide layer 115.

Further, the passivation layer 117 is to protect the upper structure of the flexible part 110, that is, the upper piezoresistor 111 and the upper piezoresistance wiring 113a. Further, the passivation layer 117 may be made of silicon oxide or silicon nitride.

By the above configuration, the inertial sensor according to the preferred embodiment of the present invention detects displacements from the upper piezoresistor 111 and the lower piezoresistor 112 each formed on the upper and lower portions of the flexible part 110 and calculates the inertial force by summing the detection signal depending on the detected displacements, such that the inertial sensor may have the improved sensing sensitivity and efficiency and may be implemented in a small and light type.

Hereinafter, the signal detection by the inertial sensor according to the preferred embodiment of the present invention will be described in detail with reference to FIGS. 2 to 5.

FIG. 2 is a diagram illustrating a wheatstone bridge structure according to a first preferred embodiment for one-axis direction signal detection, in the inertial sensor illustrated in FIG. 1. In more detail, FIG. 2A illustrates a wheatstone bridge structure for detecting a resistance change of the upper piezoresistor with respect to an X-axis direction and FIG. 2B is a wheatstone bridge structure for detecting a resistance change of the lower piezoresistor with respect to an X-axis direction.

As illustrated, a two-fold signal may be obtained by summing voltages applied between VX1− and VX1+ and between VX2− and VX2+. Further, when 1G is applied in an X-axis direction, the resistance change of the upper piezoresistor and the lower piezoresistor is as shown in the following Table 1.

TABLE 1

Upper Piezoresistor

| | 111a | 111b | 111c | 111d |
|---|---|---|---|---|
| Resistance | − | + | − | + |
| Change | | | | |

Lower Piezoresistor

| | 112a | 112b | 112c | 112d |
|---|---|---|---|---|
| Resistance | + | − | + | − |
| Change | | | | |

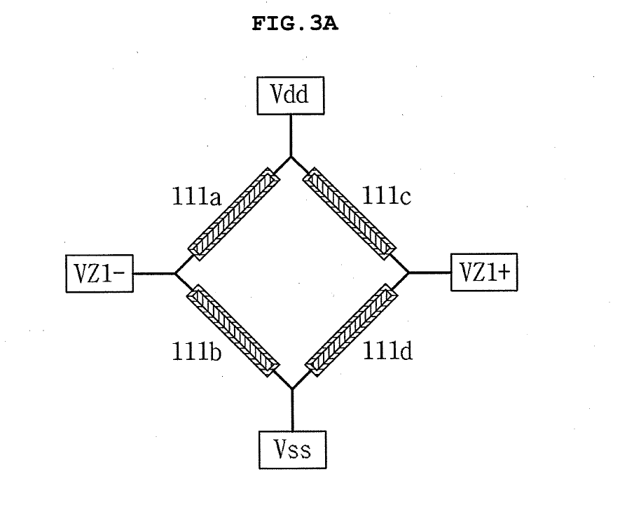

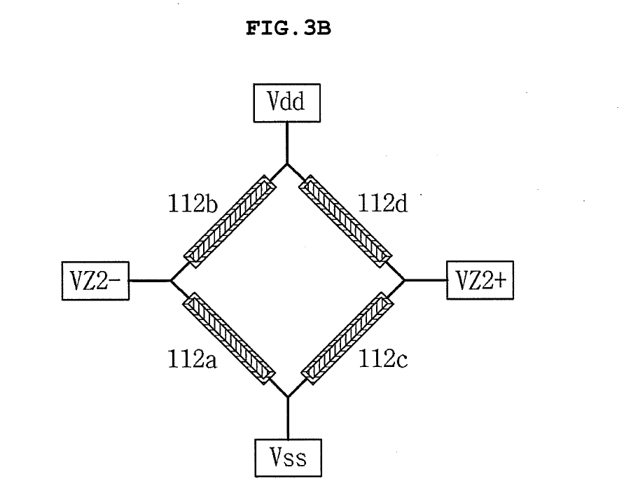

FIG. 3 is a diagram illustrating a wheatstone bridge structure according to a first preferred embodiment for the other-axis direction signal detection, in the inertial sensor illustrated in FIG. 1. In more detail, FIG. 3A illustrates a wheatstone bridge structure for detecting a resistance change of the upper piezoresistor with respect to a Z-axis direction and FIG. 3B is a wheatstone bridge structure for detecting a resistance change of the lower piezoresistor with respect to a Z-axis direction.

As illustrated, a two-fold signal may be obtained by summing voltages applied between VZ1− and VZ1+ and between VZ2− and VZ2+. Further, when 1G is applied in a Z-axis direction, the resistance change of the upper piezoresistor and the lower piezoresistor is as shown in the following Table 1.

TABLE 2

| Upper Piezoresistor | | | |
|---|---|---|---|
| 111a | 111b | 111c | 111d |

| | | | | |
|---|---|---|---|---|
| Resistance | + | − | − | + |
| Change | | | | |

Lower Piezoresistor

| | 112a | 112b | 112c | 112d |
|---|---|---|---|---|
| Resistance | − | + | + | − |
| Change | | | | |

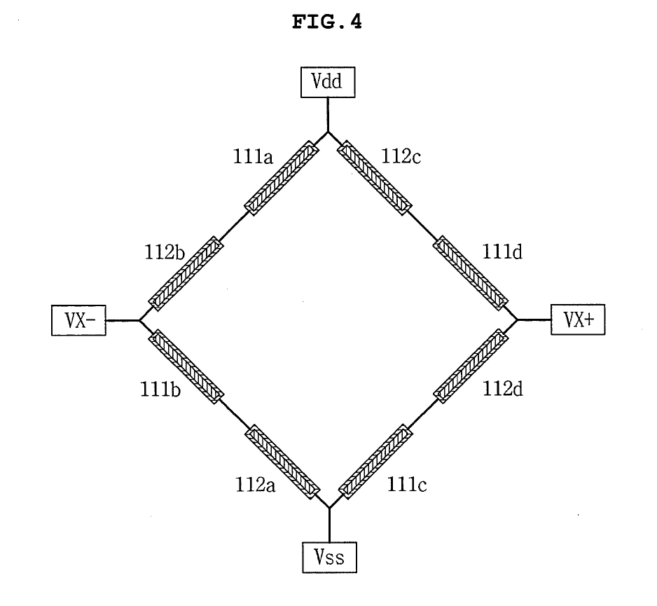

FIG. 4 is a diagram illustrating a wheatstone bridge structure according to a second preferred embodiment for one-axis direction signal detection, in the inertial sensor illustrated in FIG. 1. As illustrated, the two-fold signal may be obtained by summing the voltages of the upper piezoresistor and the lower piezoresistor applied between VX− and VX+. Further, when 1 G is applied in an X-axis direction, the resistance change of the upper piezoresistor and the lower piezoresistor is as shown in the following Table 3.

TABLE 3

Upper Piezoresistor

| | 111a | 111b | 111c | 111d |
|---|---|---|---|---|
| Resistance | − | + | − | + |
| Change | | | | |

Lower Piezoresistor

| | 112a | 112b | 112c | 112d |
|---|---|---|---|---|
| Resistance | + | − | + | − |
| Change | | | | |

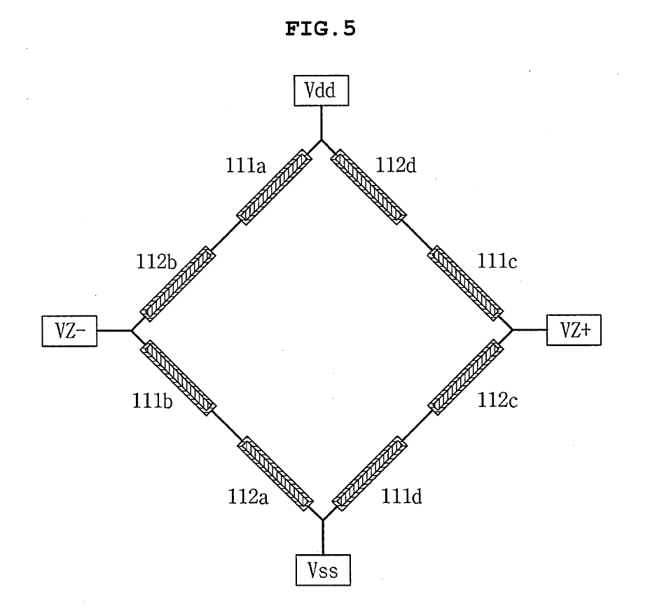

FIG. 5 is a diagram illustrating a wheatstone bridge structure according to a second preferred embodiment for the other-axis direction signal detection, in the inertial sensor illustrated in FIG. 1. As illustrated, the two-fold signal may be obtained by summing the voltages of the upper piezoresistor and the lower piezoresistor applied between VZ− and VZ+. Further, when 1 G is applied in a Z-axis direction, the resistance change of the upper piezoresistor and the lower piezoresistor is as shown in the following Table 3.

TABLE 4

Upper Piezoresistor

| | 111a | 111b | 111c | 111d |
|---|---|---|---|---|
| Resistance | + | − | − | + |
| Change | | | | |

Lower Piezoresistor

| | 112a | 112b | 112c | 112d |
|---|---|---|---|---|
| Resistance | − | + | + | − |
| Change | | | | |

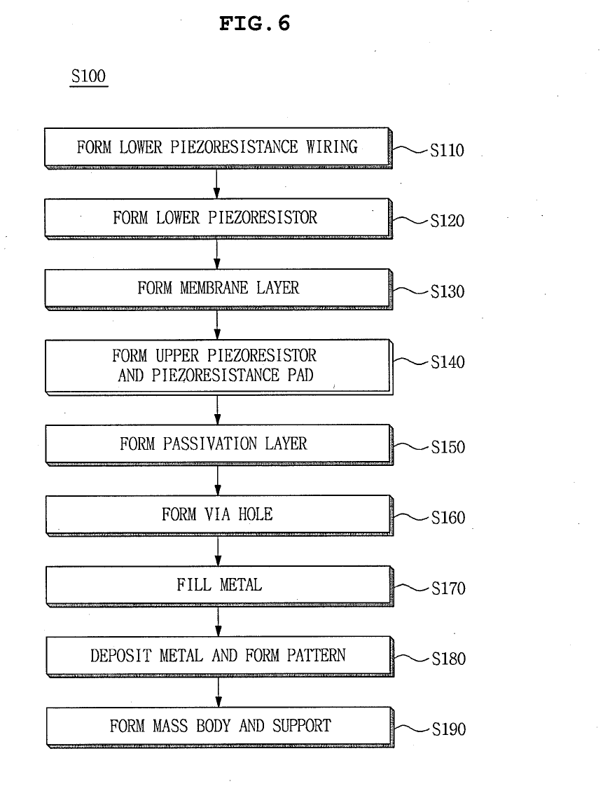

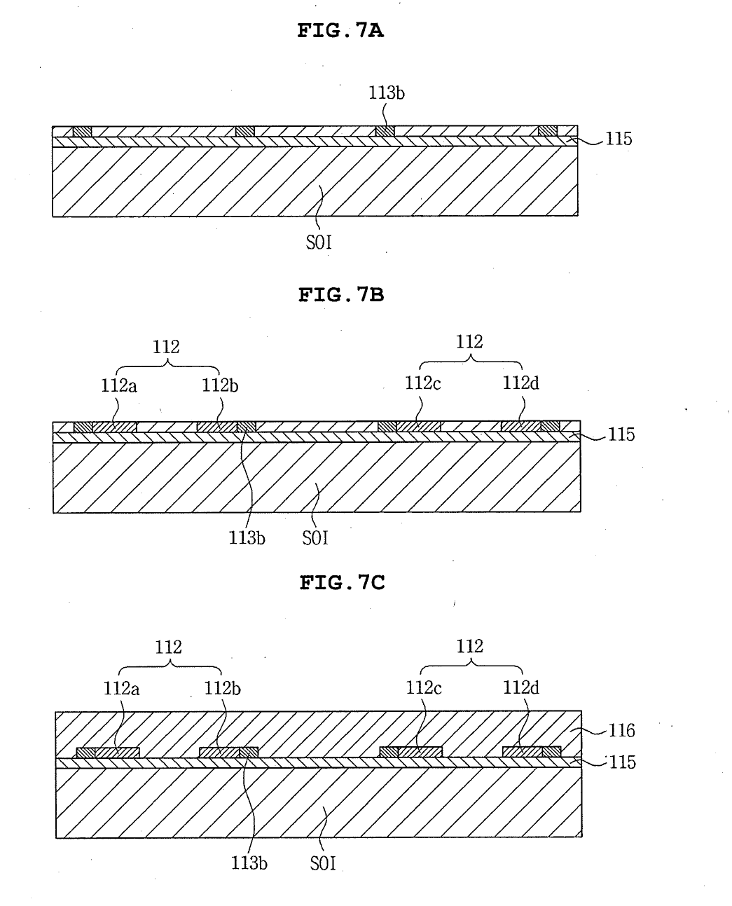

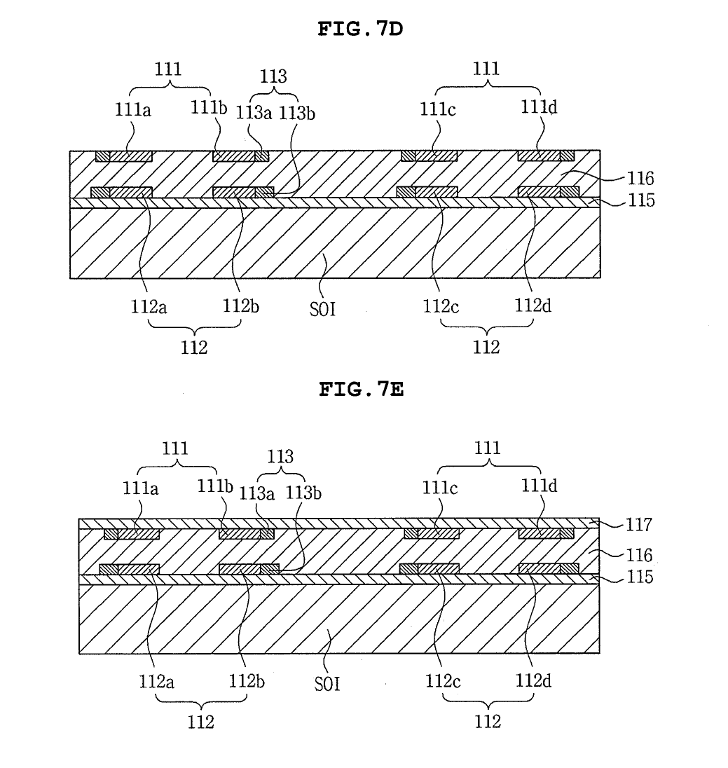

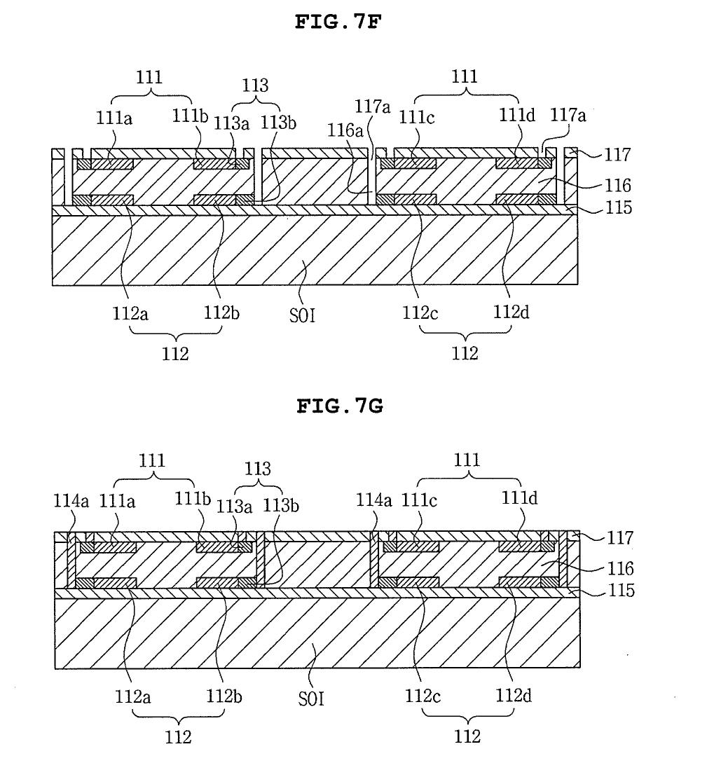

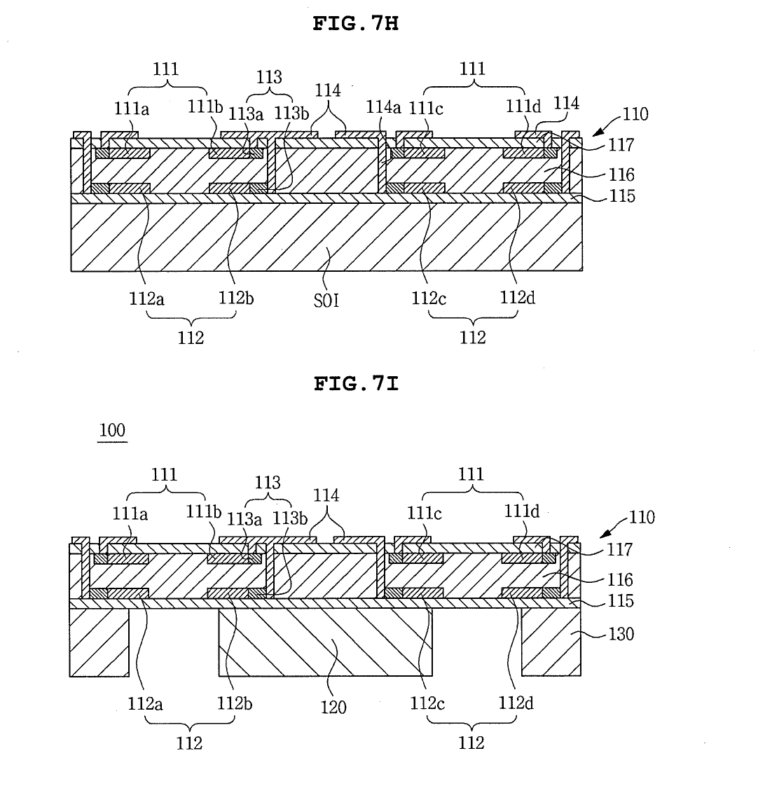

Hereinafter, a method of manufacturing an inertial sensor according to the preferred embodiment of the present invention will be described in more detail with reference to FIGS. 6 and 7.

FIG. 6 is flow chart schematically illustrating a method of manufacturing an inertial sensor illustrated in FIG. 1. As illustrated, a method of manufacturing an inertial sensor (S100) includes forming a lower piezoresistance wiring (S110), forming a lower piezoresistor (S120), forming a membrane layer (S130), forming an upper piezoresistor and an upper piezoresistance wiring (S140), forming a passivation layer (S150), forming a via hole (S160), filling a metal (S170), depositing a metal and forming a pattern (S180), and forming a mass body and a support part (S190).

FIG. 7A illustrate the forming of the lower piezoresistor wiring. In more detail, the lower piezoresistance wiring 113b is formed on an SOI substrate or a base substrate on which the mass body and the support part are disposed. Further, the silicon oxide layer 115 may be disposed on the base substrate and the lower piezoresistance wiring 113b may be disposed on one surface of the silicon oxide layer 115.

In this case, the SOI may be implemented as an N type SOL Further, the lower piezoresistor is disposed two by two at both sides of the piezoresistance wiring based on the mass body to be formed by a post-process and the lower piezoresistance wirings 113b are each disposed two by two to be each connected to the lower piezoresistors, respectively.

FIG. 7B illustrates the forming of the lower piezoresistor. In more detail, the lower piezoresistor 112 is disposed to contact the lower piezoresistance wiring 113b. Further, since the lower piezoresistance wiring 113b is disposed two by two at both sides based on the central portion of the base substrate or the SOI, the lower piezoresistors are each disposed two by two at both sides based on the central portion of the flexible part to be each connected to thereto, such that the lower piezoresistor is configured of the first lower piezoresistor 112a, the second lower piezoresistor 112b, the third lower piezoresistor 112c, and the fourth lower piezoresistor 112d.

FIG. 7C illustrates the forming of the membrane layer. In more detail, the membrane layer 116 is disposed on the lower piezoresistor 112 and the lower piezoresistance wiring 113b. As the preferred embodiment, the membrane layer 116 may be formed by depositing polysilicon and the polysilicon may be implemented as an N type polysilicon.

FIG. 7D illustrates the forming of the upper piezoresistor and the upper piezoresistance wiring. In more detail, the upper piezoresistor 111 and the upper piezoresistance wiring 113a are disposed on the membrane layer 116.

Further, the upper piezoresistor 111 and the upper piezoresistance wiring 113a are formed to contact each other. Further, the upper piezoresistor 111 is formed to face the lower piezoresistor 112. That is, the upper piezoresistors 111 are each disposed two by two at both sides based on the central portion of the flexible part and is configured of the first upper piezoresistor 111a, the second upper piezoresistor 111b, the third upper piezoresistor 111c, and the fourth upper piezoresistor 111d.

Further, the upper piezoresistance wiring 113a is formed to be connected to the first upper piezoresistor 111a, the second upper piezoresistor 111b, the third upper piezoresistor 111c, and the fourth upper piezoresistor 111d, respectively.

Further, the upper piezoresistance wiring 113a may be formed to face the lower piezoresistance wiring 113b connected to the lower piezoresistor 112.

FIG. 7E illustrates the forming of the passivation layer. As illustrated, the passivation layer 117 is disposed on the upper piezoresistor 111 and the upper piezoresistance wiring 113a. Further, the passivation layer 117 is formed to cover all of the upper piezoresistor 111 and the upper piezoresistance wiring 113a and the membrane layer 116 having the upper piezoresistor 111 and the upper piezoresistance wiring 113a formed thereon. Further, the passivation layer 117 may be made of silicon oxide or silicon nitride.

FIG. 7F illustrates the forming of the via hole. As illustrated, the via hole 116a is to form a metal wiring insertion path through which the lower piezoresistance wiring 113b and the upper piezoresistance wiring 113a are each connected to the metal wiring 114.

To this end, the via holes 116a and 117a are formed in the passivation layer 117 and the membrane layer 116. In this case, the via holes 116a and 117a are formed to connect the lower piezoresistance wiring 113b and the upper piezoresistance wiring 113a from the outside.

FIG. 7G illustrates the filling of the metal. As illustrated, a metal 114a is filled in the via holes 116a and 117a, respectively, illustrated in FIG. 6F. In this case, the filled metal 114a is injected to contact the lower piezoresistance wiring 113a or the upper piezoresistance wiring 113a.

FIG. 7H illustrates the depositing of the metal and the forming of the pattern. As illustrated, the metal wiring 114 is deposited to contact the metal 114a filled in the via hole and forms the pattern.

FIG. 7I illustrates the forming of the mass body and the support part. As illustrated, the mass body 120 and the support part 130 are formed by selectively etching the base substrate, such as the SOI substrate, and the like. Further, the mass body 120 is adjacently disposed to the lower piezoresistor 112 and the support part 130 is adjacently disposed to the lower piezoresistor 112.

By the above configuration, the inertial sensor according to the preferred embodiment of the present invention includes the upper and lower piezoresistors to be implemented as a small and light type and improve the sensitivity.

According to the preferred embodiments of the present invention, it is possible to obtain the inertial sensor which can have the improved sensing sensitivity and the efficiency by detecting the displacements from the upper piezoresistor and the lower piezoresistor each formed on the upper and lower portions of the flexible part and calculating the inertial force by summing the detection signals depending on the displacements and can be implemented in a small and light type, and the method of manufacturing the same.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. An inertial sensor, comprising:
a flexible part;
a mass body connected to the flexible part; and
a support part connected to the flexible part and supporting the mass body in a floated state to displace the mass body,
wherein the flexible part has an upper piezoresistor disposed on one surface thereof and a lower piezoresistor disposed on the other surface thereof to detect a displacement of the mass body.

2. The inertial sensor as set forth in claim 1, wherein the flexible part includes an upper piezoresistance wiring electrically connected to the upper piezoresistor and a lower piezoresistance wiring electrically connected to the lower piezoresistor.

3. The inertial sensor as set forth in claim 2, wherein the flexible part includes membrane layers formed on the lower piezoresistor and the lower piezoresistance wiring.

4. The inertial sensor as set forth in claim 2, wherein the flexible part includes a metal wiring electrically connected to the upper piezoresistance wiring and the lower piezoresistance wiring, the metal wiring being exposed to an outside of the flexible part.

5. The inertial sensor as set forth in claim 4, wherein the flexible part is provided with a metal via hole through which the metal wirings are connected to the upper piezoresistance wiring and the lower piezoresistance wiring.

6. The inertial sensor as set forth in claim 5, wherein the flexible part includes a passivation layer covering the upper piezoresistor and the upper piezoresistance wiring.

7. The inertial sensor as set forth in claim 1, wherein the upper piezoresistor and the lower piezoresistor are adjacently disposed to the mass body.

8. The inertial sensor as set forth in claim 7, wherein the upper piezoresistor and the lower piezoresistor are each disposed two by two at both sides based on the mass body to be symmetrical with each other.

9. The inertial sensor as set forth in claim 1, wherein the upper piezoresistor and the lower piezoresistor are adjacently disposed to the support part.

10. The inertial sensor as set forth in claim 9, wherein the upper piezoresistor and the lower piezoresistor are each adjacent to the support part and are disposed two by two to be symmetrical with each other.

11. A method of manufacturing an inertial sensor, comprising:
(A) forming a lower piezoresistance wiring on a base substrate;
(B) forming a lower piezoresistor to contact the lower piezoresistance wiring;
(C) forming a membrane layer on the lower piezoresistor and the lower piezoresistance wiring; and
(D) forming the upper piezoresistor and the piezoresistance wiring on the membrane layer to contact an upper piezoresistor and an upper piezoresistance wiring.

12. The method as set forth in claim 11, wherein in the (A), a silicon oxide layer is disposed on the base substrate and the lower piezoresistance wiring is disposed on the silicon oxide layer.

13. The method as set forth in claim 11, wherein in the (A), the lower piezoresistance wiring is formed two by two at both sides based on a central portion of the base substrate.

14. The method as set forth in claim 11, wherein in the (B), the lower piezoresistor is disposed two by two at both sides based on a central portion of the base substrate to form a first lower piezoresistor, a second lower piezoresistor, a third lower piezoresistor, and a fourth lower piezoresistor.

15. The method as set forth in claim 11, wherein in the (D), the upper piezoresistor is disposed two by two at both sides based on a central portion of the base substrate to form a first upper piezoresistor, a second upper piezoresistor, a third upper piezoresistor, and a fourth upper piezoresistor.

16. The method as set forth in claim 11, further comprising: after the (D), (E) forming a passivation layer on the upper piezoresistor and the upper piezoresistance wiring.

17. The method as set forth in claim 16, further comprising: after the (E), (F) forming a via hole through which a metal wiring insertion path is formed in the membrane layer and the passivation layer to connect the metal wiring to the lower piezoresistance wiring and the upper piezoresistance wiring, respectively.

18. The method as set forth in claim 17, further comprising: after the (F), (G) filling a metal in the via hole.

19. The method as set forth in claim 18, further comprising: after the (G), (H) deposing a metal wiring to contact the metal filled in the via hole and forming a pattern.

20. The method as set forth in claim 19, further comprising: after the (H), (I) forming a mass body and a support part by selectively etching the base substrate.
